(19) United States
(12) Patent Application Publication
(10) Pub. No.: US 2025/0018551 A1
(43) Pub. Date: Jan. 16, 2025

(54) MOP HANDLE WITH GRIP

(71) Applicant: Concept Manufacturing, Inc., Chino, CA (US)

(72) Inventor: Rikard Ingemarsson Hedlund, Studio City, CA (US)

(73) Assignee: Concept Manufacturing, Inc., Chino, CA (US)

(21) Appl. No.: 18/770,142

(22) Filed: Jul. 11, 2024

Related U.S. Application Data
(60) Provisional application No. 63/512,943, filed on Jul. 11, 2023.

(51) Int. Cl. B25G 1/10; A47L 13/20; B25G 3/28; B25G 3/38

(52) U.S. Cl. CPC B25G 1/102; B25G 3/28; B25G 3/38; A47L 13/20

(57) ABSTRACT

A system for cleaning comprising an elongated element comprising a top part, wherein the top part is a rectilinear first portion that extends along a longitudinal axis; a bottom part, wherein the bottom part comprises a mating component configured to receive a removable attachable head; and an intermediate zone, wherein the intermediate zone links the top part and bottom part. The system for cleaning further comprises a head element, wherein the head element if removably attached to the bottom part of the elongated element; and at least one grip element that is removably attached to the top part of the elongated element and is configured to allow the elongated element to rotate free of the grip element.

### TECHNICAL FIELD

This application claims the benefit of priority to U.S. Provisional Application No. 63/512,943, filed Jul. 11, 2023, which is incorporated herein by reference in its entirety.

The present disclosure generally relates to systems for cleaning. More particularly, this disclosure is directed toward a cleaning system comprising an elongated element, a grip element, and a head element. In some embodiments, the elongated element may be shaped such that the effectiveness of cleaning is improved, and the grip may be attached such that the physical fatigue and injury of the user is reduced.

### BACKGROUND

Cleaning systems are useful for removing soils, stains, and debris from hard surfaces. Typical cleaning systems comprise a handle portion, a grip portion, and a cleaning element. Current handle portions are designed as either a singular, monoblock design for a specific length or a multi-piece, modular construction that allows for the handle portion to adjust to a length determined by the user.

During use, the user typically places one hand on the grip portion of the cleaning system, which is located on the distal end of the system, for stabilization and places another hand on the handle portion for directing movement of the cleaning system. Due to the inflexible nature of the handle materials and the design of current cleaning systems, the user may experience increased physical fatigue and injury, such as blisters, callouses, joint pain, and muscle strain, during use.

The disclosed cleaning system is directed to overcoming one or more of the problems set forth above and/or other problems of the prior art.

### SUMMARY

In one embodiment, there is described a system for cleaning comprising an elongated element comprising a top part, wherein the top part is a rectilinear first portion that extends along a longitudinal axis; a bottom part, wherein the bottom part comprises an arc that extends away from the longitudinal axis and comprises a mating component configured to receive a removably attachable head; and an intermediate zone, wherein the intermediate zone links the top part and bottom part.

The system for cleaning according to one embodiment further comprises a head element, wherein the head element is removably attached to the bottom part of the elongated element; and at least one grip element that is removably attached to the top part of the elongated element and is configured to allow the elongated element to rotate free of the grip element.

### BRIEF DESCRIPTION OF THE DRAWINGS

The accompanying figures are incorporated in, and constitute a part of, this specification.

FIG. 1 illustrates a cleaning system assembly according to the present disclosure where the grip element is not present.

FIG. 2 illustrates an elongated element and knob grip of the cleaning system assembly of FIG. 1.

FIG. 3 illustrates a detail view of a removably attachable cleaning head and mating mechanism between the cleaning head element and elongated element of the cleaning system assembly of FIG. 1.

FIG. 4A illustrates a detail view of a grip element of a cleaning assembly according to one embodiment of the present disclosure.

FIG. 4B illustrates an elongated element and grip element of a cleaning assembly according to one embodiment of the present disclosure.

FIG. 5A illustrates one embodiment of a grip element of a cleaning assembly according to one embodiment of the present disclosure.

FIG. 5B illustrates an isometric view of the grip element of FIG. 5A.

FIG. 6A illustrates another embodiment of a grip element of a cleaning assembly according to one embodiment of the present disclosure.

FIG. 6B illustrates an isometric view of the grip element of FIG. 6A.

FIG. 7 illustrates a textile pad for assembly onto a head element according to one embodiment of the present disclosure.

FIGS. 8A-8D illustrate various views of an assembly stem according to one embodiment of the present disclosure. FIG. 8A is a side view of the assembly stem according to one embodiment of the present disclosure. FIG. 8B is a front view of the assembly stem of FIG. 8A. FIG. 8C is a top view of the assembly stem of FIG. 8A. FIG. 8D is a perspective of the assembly stem of FIG. 8A.

FIGS. 9A-9D illustrate various views of an attachment clip according to one embodiment of the present disclosure. FIG. 9A is a side view of the attachment clip according to one embodiment of the present disclosure. FIG. 9B is a front view of the attachment clip of FIG. 9A. FIG. 9C is a top view of the attachment clip of FIG. 9A. FIG. 9D is a perspective of the attachment clip of FIG. 9A.

### DETAILED DESCRIPTION

The present disclosure relates to cleaning systems. Disclosed embodiments may have a variety of different applications, including wet mops and dust sweepers.

Current systems for cleaning comprise a handle portion, a grip portion, and a cleaning element. When using the system, the user typically places one hand on the grip portion, which is located on the distal end, to stabilize the system and places the other hand on the handle portion to direct movement of the system. Due to the inflexible nature of the handle materials, the design of current cleaning systems, and the repetitive motions involved in using these systems for cleaning, the user may experience physical fatigue and injury such as blisters, callouses, joint pain, and muscle strain during use. Thus, it is desirable to provide a system for cleaning designed to increase cleaning efficiency and reduce fatigue and injury to the user.

A cleaning system may comprise an elongated element, a head element, and at least one grip element. Consistent with disclosed embodiments, an elongated element may comprise a top part, a bottom part, and an intermediate zone. In the present disclosure, the term “proximal” refers to the end of the system that is closer to the head element, and the term “distal” refers to the end of the system that is further from the head element. The elongated element may be a handle of a mop. It is contemplated that a cross-section of the elongated element may be of any shape, such as, but not limited to, circular, triangular, rectangular, pentagonal, hexagonal, and/or octagonal. It is further contemplated that the top part, bottom part, and intermediate zone of the elongated element may be the same or different shapes. For example, the top part, bottom part, and intermediate zone of the elongated element may each have a circular cross-section. As another example, the top part and the bottom part of the elongated element may have a hexagonal cross-section, and the intermediate zone of the elongated element may have a circular cross-section.

In some embodiments, the elongated element may be made of fiberglass, wood, or an alloy such as aluminum. The elongated element may be formed using a variety of methods, including but not limited to a machining process, such as a single billet of material. The diameter of the elongated element may be 25 mm. In one embodiment, the elongated element may comprise an inner pole and an outer pole. The inner pole may be made of oxidized aluminum. The outer pole may be made of aluminum. The outer pole may be coated by paint or any other material that increases corrosion resistance.

The top part may be a rectilinear first portion that extends along a longitudinal axis. The longitudinal axis may be the central axis of the rectilinear first portion.

The bottom part may comprise an arc that extends away from the longitudinal axis. The bottom part may further comprise a mating component configured to receive a removable attachable head element. The mating component may comprise a variety of mating mechanisms, including but not limited to a press fit, latch, hinge, or screw connection. In one embodiment, the mating component may comprise one or more punch holes at the distal end of the elongated element. The mating mechanism may comprise attaching the head element and bottom part together via screws and the punch holes. The mating component, or coupling device, may provide at least two degrees of freedom in rotation between the head element and elongated element.

The arc of the bottom part may comprise an arc length between 40 and 60 centimeters with an angle of 60°. In some embodiments, the bottom part may extend away from the longitudinal axis at an angle of 60°.

The intermediate zone may link, or connect, the top part and the bottom part. The link mechanism may comprise a press fit or slip-on mechanism. The elongated element may comprise a telescopic portion between the top part and the intermediate zone and/or the bottom part and the intermediate zone. The telescopic portion may comprise a latch or slip-on mechanism to facilitate the collapsing of the top part, intermediate zone, and/or bottom part together. The collapsing of the top part, intermediate zone, and/or bottom part together may facilitate easier storage of the cleaning system. In one embodiment, the collapsing of the top part, intermediate zone, and/or bottom part may comprise the storing of one part within another. For example, a telescopic portion between the top part and the intermediate zone may facilitate the collapsing of the top part and intermediate zone together, wherein the intermediate zone is stored within the top part.

In some embodiments, the top part may extend over a first distance, and the bottom part of the elongated element may extend over a second distance. The second distance may be less than one-third of the first distance. In one embodiment, the elongated element may be 117 cm to 180 cm long.

In some embodiments, the top part may comprise a knob grip. The knob grip may comprise a knob, a mid cover, and a shelf. Additionally, the knob grip may be attached to the top part of the elongated element via slip on, press fit, latches, or screws. In one embodiment, the knob grip may be located at the distal end of the elongated element. The knob may be located at the distal end of the knob grip. The shelf may be located at the proximal end of the knob grip.

The head element may be removably attached to the bottom part of the elongated element via methods described above, such as a snap or press fit, latches, hinge, and threaded or screw mechanisms. In an embodiment, the threaded or screw mechanism may involve a threaded end on the assembly stem and a corresponding threaded socket on the elongated element or frame. In another embodiment, the threaded or screw mechanism may involve a threaded end on the elongated element or frame and a corresponding threaded socket on the assembly stem. In both embodiments, the components may be connected by twisting them together, creating a firm and secure attachment. Threaded mechanisms may provide stability during cleaning and prevent accidental detachment.

In an embodiment, the head element may be removably attached to the bottom part of the elongated element using a quick-release mechanism. This may allow for easy and quick attachment and detachment of components without the need for twisting or unscrewing. The quick-release mechanism may involve a locking mechanism or a lever that can be pressed or activated to release or secure the mop head, frame, or other attachments.

In an embodiment, the quick-release mechanism may be in the form of a clip or snap-on configuration. For example, the quick-release mechanism may achieve attachments through clips or snap-on elements that use a friction or spring-loaded clip or snap connector that securely holds the components in place. The components can be attached by simply pressing or snapping them together. Clip or snap-on mechanisms offer convenience and ease of use.

In an embodiment, the clip or snap-on mechanism may be is configured to allow for only one (correct or intended) method of removably attaching the head element to the bottom part of the elongated element. This may be achieved by incorporating specific features or shapes into the attachment points of the various components. For example, as described herein, the bottom part of the disclosed system may comprise an arc that extends away from the longitudinal axis and may comprise a mating component configured to receive a removably attachable head element. The mating component may be described as an assembly stem that includes a unique shape or notches that match and interlock with a corresponding shape or notch on the pole. This ensures that the components can only be attached correctly when aligned properly. Attempting to attach them in any other way would result in misalignment and prevent a secure connection.

In an embodiment, the assembly stem may comprise one or more unique notches that is configured to receive an elongated member having protrusions in the shape that fit within and interlock with the one or more notches. In an embodiment, there is provided an arrangement in which the pole and the assembly stem can be connected in only one configuration. In one embodiment, the protrusions are located on a clip that is secured in the pole with friction and that snaps into the keyholes or key slots located on the assembly stem. In one embodiment, the clip is made of a hard plastic that has some flexibility such that it can bend to fit within the tubular pole of the elongated member. This clip is described herein as a “v-clip.”

In an embodiment, the assembly stem may comprise a key configuration, which involves incorporating key-like protrusions or indentations on the attachment points, such as on the end of the elongated pole. For example, the end of the elongated pole may be configured with corresponding keyholes or key slots that match the shape of the keys. This may allow for a correct (or intended) alignment and attachment of the components, while alternative orientations would not fit or align properly. In one embodiment, the key-like protrusions are located on a v-clip that is located within the pole and that snaps into the keyholes or key slots located on the assembly stem.

In an embodiment the v-clip can be made of a hard, flexible, or bendable plastic that can bend or compress to be inserted within the tubular structure of the elongated pole while retaining its structural integrity. This plastic combines the properties of rigidity and flexibility, allowing it to bend or deform to a certain extent without breaking or permanently deforming.

There are various types of flexible plastics available, each with its own specific properties and applications. The following is a non-limiting list of plastics that can be used for disclosed v-clips: polypropylene (PP); acrylonitrile butadiene styrene (ABS); polycarbonate (PC); and polyethylene (PE).

In one embodiment, the clip or snap-on mechanism may be used alone or in combination with a color coding or symbol coding system to further ensure correct (or intended) assembly of the described cleaning system. For example, the described clips or snap connectors may be designed with specific colors or symbols, and the attachment points can be marked accordingly. This would allow visual guides for the user to align and attach the components correctly, as only the matching colors and/or symbols will fit together.

These design techniques can help ensure that the components are attached in the intended (e.g., correct) configuration, minimizing the risk of incorrect assembly and promoting proper functionality and stability of the cleaning system. It provides a foolproof method to prevent users from attaching the components in a way that could compromise the effectiveness of the cleaning device or safety of its user.

The head element may comprise a receptacle for receiving the bottom part of the elongated element. The receptacle may be located at the center of the head element. The head element may be rectangular or trapezoidal in shape. In one embodiment, the head element may be 10 cm wide and 40 cm long. In another embodiment, the head element may be 8 cm wide and 40 cm long. Various textiles may be attached to the head element to facilitate different kinds of cleaning, such as mopping and dusting.

As discussed above, the bottom part of the elongated element may fit within the head element via the receptacle. It is contemplated that, in some embodiments, the head element may fit within the bottom part of the elongated element, such that the connection between the head element and the bottom part involves insertion of a portion of the head element the bottom part of the elongated element (and the bottom part of the elongated element, or the entire elongated element, may be hollow).

The grip element may be removably attached to the top part of the elongated element. Furthermore, the grip element may be configured to allow the elongated element to rotate free of the grip element. In other words, the grip element may be attached to the elongated element such that the grip element remains stationary while the elongated element rotates about the longitudinal axis, the grip element rotates about the longitudinal axis while the elongated element remains stationary, the grip element and elongated element rotate in different directions about the longitudinal axis, or the grip element and elongated element rotate in the same direction about the longitudinal axis. Upon squeezing the handle grip, the free rotation of the elongated element within the grip element may be halted and a handle control similar to a fixed handle cleaning system may be restored. The rotation of the elongated element within the grip element may relieve strain on the hand of the user.

The grip element may be made of molded plastics, rubberized materials, or softer neoprene materials. For example, the grip element may be made of a material that comprises at least one of ethylene-vinyl acetate, polypropylene, or polychloroprene. The method of removing and/or attaching the grip element may comprise a hook-and-loop fastener, snap connection, and/or slip on. In one embodiment, the grip element may comprise a hook-and-loop fastener mechanism and enclose the entire diameter of the elongated element. In another embodiment, the grip element may comprise a snap connection and enclose a portion of the entire diameter of the elongated element, for example, three-fourth of the diameter.

In one embodiment, the grip element may comprise a molded plastic or synthetic rubber that includes ridges. The ridges may be conducive to enhancing the user grip and comfort. In some embodiments, the surface of the grip element may be smooth or textured to provide a secure hold, even when wet. Textured grips, such as those with ridges, can prevent slipping and improve control while mopping. Overall, the grip element is designed to enhance user comfort, control, and efficiency during the cleaning process, providing a stable and ergonomic interface between the user and the head element.

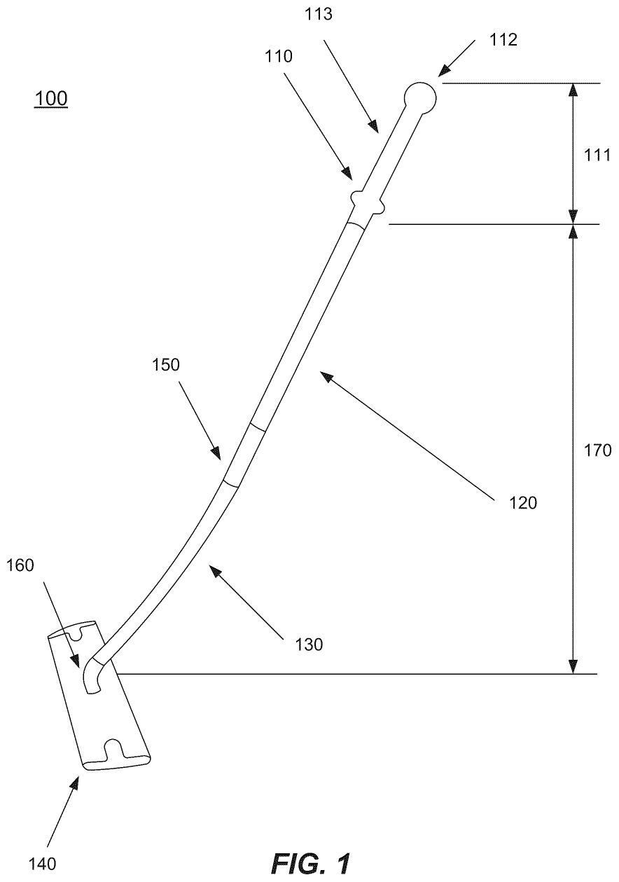

By way of example, FIG. 1 illustrates a cleaning system assembly 100 according to the present disclosure where the grip element is not present. The cleaning system assembly 100 comprises an elongated element 170 comprising a top part 120, intermediate zone 150, and bottom part 130. The cleaning system assembly 100 may further comprise a knob grip 111, wherein the knob grip 111 comprises a knob 112, mid cover 113, and shelf 110. Additionally, the cleaning system assembly 100 may comprise a head element 140 wherein the head element 140 can be removably attached to the elongated element 170 via a mating component 160.

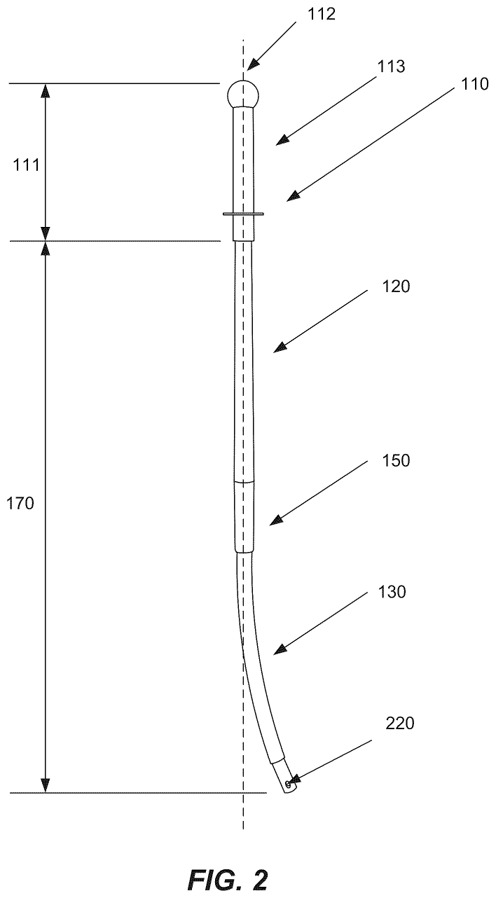

In another example, FIG. 2 illustrates an elongated element and knob grip 111 of a cleaning system assembly of the cleaning system of FIG. 1. The cleaning system assembly may comprise a top part 120, intermediate zone 150, and bottom part 130. The bottom part 130 may comprise two punch holes 220. The punch holes 220 may facilitate a screw mating mechanism that couples the bottom part 130 and the head element (not shown).

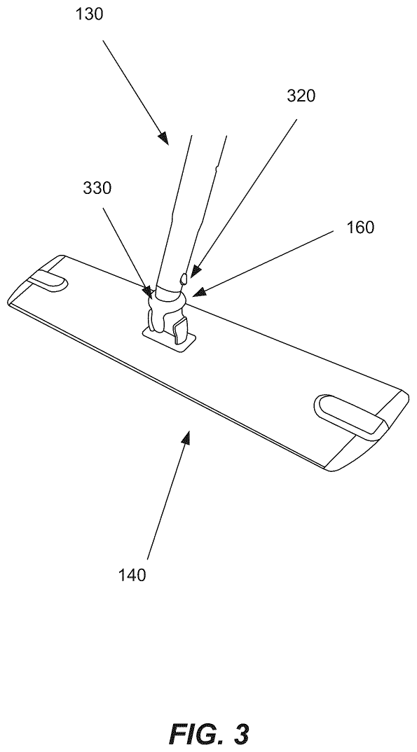

FIG. 3 illustrates a detail view of the mating component 160 between the head element 140 and bottom part 130 of the elongated element of the cleaning system assembly of FIG. 1. In the shown embodiment, the mating component 160 may comprise a receptacle 330 on the head element 140 for receiving the bottom part 130 of the elongated element. The mating mechanism may comprise a screw assembly, as shown in FIG. 3. Screws 320 may be used to secure the head element 140 to the bottom part 130.

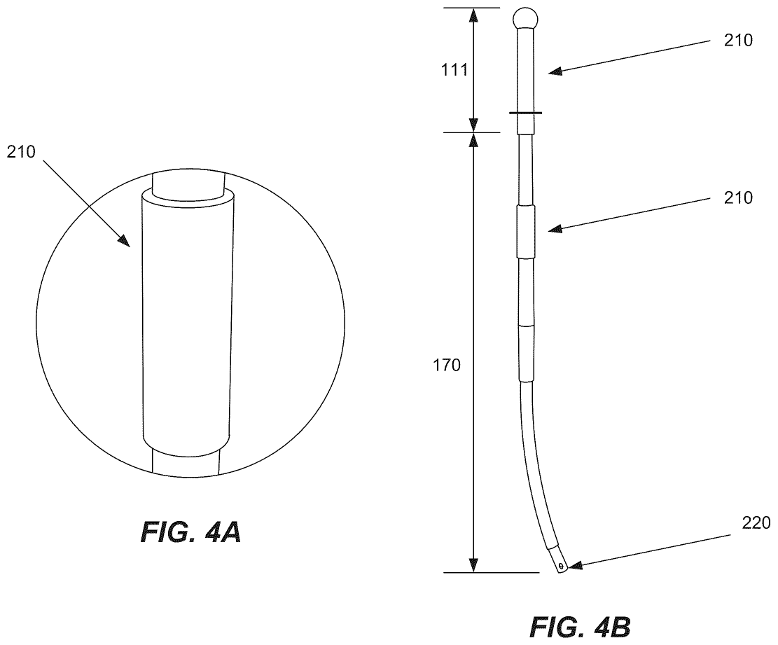

FIG. 4A illustrates a detail view of a grip element 210 of a cleaning assembly. Additionally, FIG. 4B illustrates an elongated element 170 and grip element 210 of a cleaning assembly. As shown in FIGS. 4A-B, the grip element 210 may be attached to the elongated element 170 via a slip-on mechanism. The knob grip 111 may be attached to the elongated element 170 via slip on, press fit, latches, or screws. The elongated element 170 may further comprise punch holes 220 at the distal end.

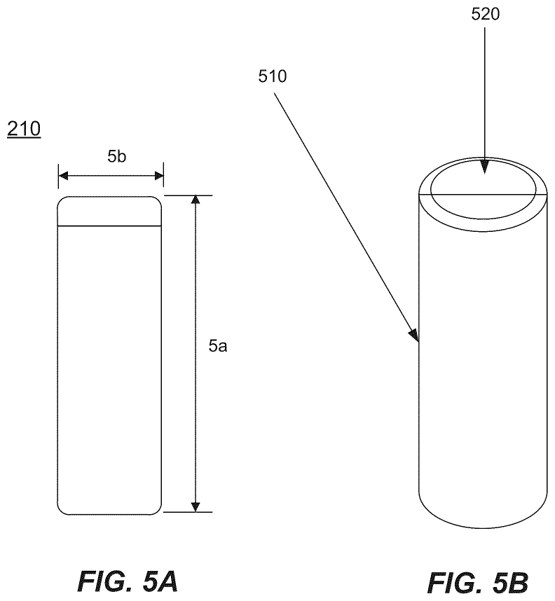

In FIG. 5A, a grip element 210 of a cleaning assembly according to the present disclosure is shown. The grip element may be of width 5a and diameter 5b. In some embodiments the width 5a may be 110 mm and the diameter 5b may be 37 mm. FIG. 5B is an isometric view of a grip element 210 of a cleaning assembly according to the present disclosure. The inner portion 520 of the grip element may be made of polypropylene. The outer portion 530 of the grip element may be made of ethylene-vinyl acetate.

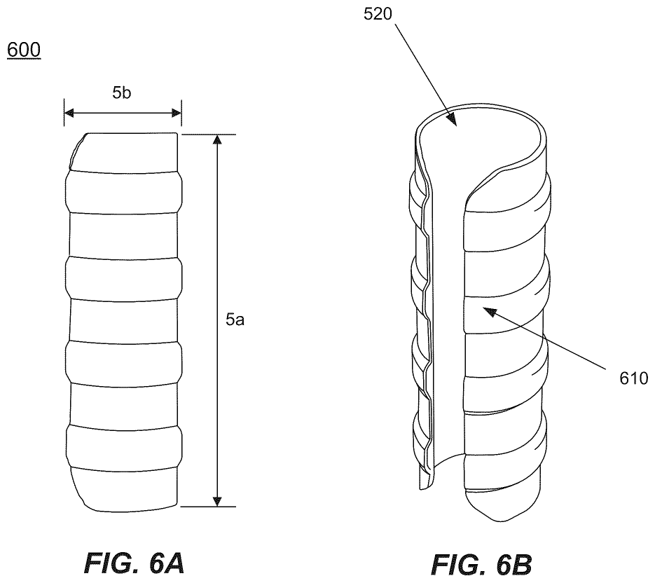

In another embodiment, as shown in FIGS. 6A-B, a grip element 210 of a cleaning assembly according to the present disclosure may comprise ridges 610. Further, the grip element 210 may be a snap on design wherein the grip does not enclose the entire elongated element (not shown). Ridges 610 may enhance user grip and comfort. The width 5a of the grip element 210 may be 110 mm and the diameter 5b of the grip element 210 may be 37 mm. The inner surface 520 of the grip element 210 shown in FIG. 6B may be polypropylene.

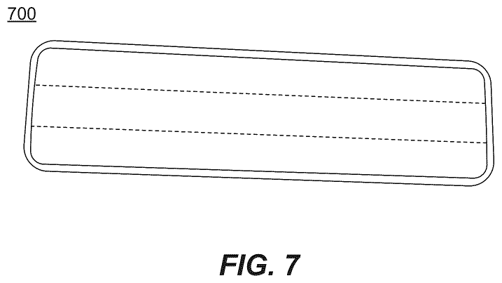

FIG. 7 illustrates a textile pad 710 that may be removably attached to the head element 140 (shown in FIG. 1). Different textiles may facilitate different types of cleaning. For example, a textile pad 710 made of microfiber may facilitate dust sweeping.

In one embodiment, the textile pad may comprise a cleaning pad of ultrasonic-bonded construction comprising: a surface cleaning layer comprising a microfiber material; a backing layer comprising an attachment surface; and at least one fluid absorbing layer, comprising at least one fluid absorbing material located between the surface cleaning layer and the backing layer, wherein the surface cleaning layer, the backing layer and the at least one fluid absorbing layer form a multilayer composite that are integrally attached with one or more ultrasonic weld lines configured to form pockets of expansion in said multilayer composite.

As used herein, the term “microfiber” refers to a fiber that is one denier or smaller. Microfibers are generally constructed from split conjugated fibers of polyester and polyamide. The microfibers that can be used in the present disclosure may substantially comprise polyester, polyamide, nylon, acrylic and/or other synthetic and non-synthetic materials. In one embodiment, the microfiber used herein comprises polypropylene (PP)/polyethylene terephthalate (PET). In one embodiment, the microfiber material comprises recycled PET, such as 50% recycled PET or more.

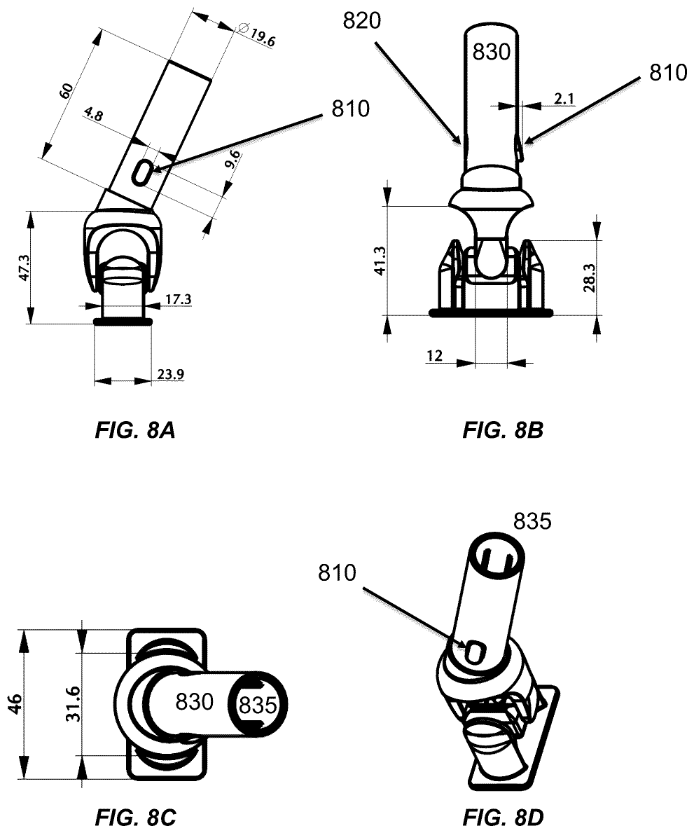

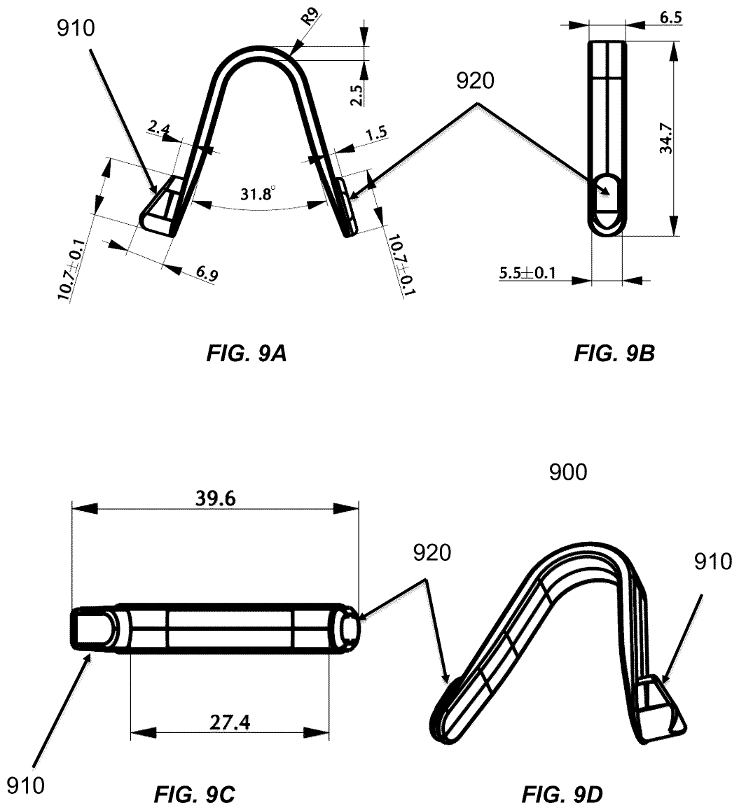

In one embodiment, and with reference to FIGS. 8A-8B, there is described an assembly stem 800 that connects the elongated member or pole with the cleaning head. With reference to FIG. 8A, there is shown a side view of the assembly stem 800 with an opening or notch 810 for receiving a protrusion that is associated with the elongated member or pole. The phrase “associated with”, as used herein, means that the pole itself may contain such protrusions to fit within the opening or notch, or may be fitted with a clip that contains such protrusions, such as shown in FIGS. 9A-9D.

FIG. 8B shows the location of different opening or notches 810 and 820 on opposite sides of the assembly stem 800. FIG. 8C and FIG. 8D show the assembly stem comprises a tubular structure 830 having a hollow interior and an open end 835 that allows the insertion of the elongated member or pole therein. In one embodiment, the tubular structure 830 of the assembly stem has a slightly larger diameter than the elongated member or pole, allowing it to slide over the end of the elongated member or pole, ensuring a firm fit and stable connection when used in combination with the snap or clip attachment described herein. In one embodiment, the assembly stem may have a protective finish, such as paint or powder coating, to enhance its durability and resistance to environmental elements.

With reference to FIGS. 9A-9D, in one embodiment, the elongated member has protrusions 910 and 920 having a shape that fits within and interlocks with the openings of the assembly stem. See, e.g., FIGS. 8A and 8B, specifically the disclosed assembly stem 800 having one or more unique openings 810 and 820 that are configured to receive an elongated member having protrusions in the shape that fit within and interlock with the openings 810 and 820.

In one embodiment, the protrusions are located on the end of the elongated pole. As illustrated in FIGS. 1 and 2, depending on the desired embodiment, the bottom part elongated pole 130 may be configured with protrusions or punch holes 220, which may facilitate a mating mechanism that couples the bottom part 130 and the head element 140. In another embodiment, the protrusions may be located on a clip that is configured to be located within the end of the elongated pole. This attachment clip is meant to snap into the keyholes or key slots located on the assembly stem. FIG. 9A is a side view a u-shaped attachment clip 900 according to the present disclosure. FIGS. 9A and 9B show protrusion 910 and 920, which fit into recesses 810 and 820, respectively, as shown in attachment assembly 800 of FIGS. 8A and 8B.

In one embodiment, the u-shaped attachment clip 900 according to the present disclosure relies on spring-loaded friction to remain secure within the tubular structure of the elongated member. This mechanism allows for easy insertion, adjustment, and removal of the element while maintaining a secure hold.

In an embodiment, the interior surface of the elongated tubular structure may be designed to increase friction or resistance against the u-shaped attachment clip 900. Additionally, or alternatively, the u-shaped attachment clip described herein may have a surface that also increases friction or resistance against the interior wall of the elongated member. Non-limiting methods of increasing friction on the surface of the interior tubular wall or the surface of the v-clip include using a textured surface, applying a non-slip material, or adding gripping elements like ridges or teeth.

Disclosed embodiments may include any one of the following bullet-pointed features alone or in combination with one or more other bullet-pointed features, whether implemented as a device, system, apparatus, and/or method.
a system for cleaning.
an elongated element comprising: a top part, wherein the top part is a rectilinear first portion that extends along a longitudinal axis.
an elongated element comprising a bottom part, wherein the bottom part comprises an arc that extends away from the longitudinal axis and comprises a mating component configured to receive a removably attachable head element.
an elongated element comprising an intermediate zone, wherein the intermediate zone links the top part and bottom part.
a cleaning head element that is removably attached to the bottom part of the elongated element.
at least one grip element that is removably attached to the top part of the elongated element and is configured to allow the elongated element to rotate free of said grip element.
a system for cleaning wherein, in the direction of the longitudinal axis, the top part of the elongated element extends over a first distance, and the bottom part of the elongated element extends over a second distance that is less than one-third of the first distance.
a system for cleaning wherein the elongated element comprises a telescopic portion between the top part and the intermediate zone.
a system for cleaning wherein the elongated element comprises a telescopic portion between the intermediate zone and the bottom part.
a system for cleaning wherein the bottom part extends away from the longitudinal axis for an arc length between 40 centimeters and 60 centimeters with an angle of 60 degrees.
a system for cleaning wherein the top part of the elongated element comprises a knob disposed at the distal end of the elongated element.
a system for cleaning wherein the grip element is moveable in rotation relative to the elongated element around the longitudinal axis.
a system for cleaning wherein the grip element comprises a molded plastic or synthetic rubber that includes ridges.
a system for cleaning wherein the grip element is made of a material that comprises at least one of ethylene-vinyl acetate, polypropylene, or polychloroprene.
a system for cleaning wherein the head element is connected to the bottom part of the elongated element with a coupling device that provides at least two degrees of freedom in rotation between the head element and elongated element.
a system for cleaning wherein the cleaning head element comprises a cleaning pad of ultrasonic-bonded construction.
a system for cleaning wherein the cleaning head element comprises a surface cleaning layer comprising a microfiber material.
a system for cleaning wherein the cleaning head element comprises
a system for cleaning wherein the cleaning head element comprises a backing layer comprising an attachment surface.
a system for cleaning wherein the cleaning head element comprises at least one fluid absorbing layer.
a system for cleaning wherein the cleaning head element comprises at least one fluid absorbing layer comprising at least one fluid absorbing material located between the surface cleaning layer and the backing layer.
a system for cleaning wherein the cleaning head element comprises a surface cleaning layer, a backing layer, and at least one fluid absorbing layer that form a multilayer composite that are integrally attached with one or more ultrasonic weld lines configured to form pockets of expansion in said multilayer composite
a system for cleaning wherein the at least one fluid absorbing layer comprises absorptive nonwoven material.
a system for cleaning wherein the absorptive nonwoven material comprises a spun bonded polypropylene layer.
a system for cleaning wherein the attachment surface comprises a hook and loop material projecting away from the surface cleaning layer.
a system for cleaning wherein the mating component includes an assembly stem having a top element comprising a hollow tube with at least one opening located in the sidewalls of the tube, the opening having the shape of a corresponding protrusion located in or on the elongated element, wherein the opening is configured to accept with the corresponding protrusion.
a system for cleaning wherein the hollow tube of the assembly stem has a larger diameter than the elongated element.
a system for cleaning wherein the protrusions are located on a clip that is secured within the elongated element.
a system for cleaning wherein the protrusions located on the clip reversibly snap into the openings located in the sidewalls of the tube on the assembly stem to allow for attachment and detachment of the cleaning head.
a system for cleaning wherein the clip is made from a plastic and comprises polypropylene (PP); acrylonitrile butadiene styrene (ABS); polycarbonate (PC); and polyethylene (PE).

It will be apparent to those skilled in the art that various modifications and variations can be made to the disclosed cleaning system without departing from the scope of the disclosure. Alternative implementations will be apparent to those skilled in the art from consideration of the specification and practice disclosed herein. It is intended that the specification and examples be considered as exemplary only, with a true scope of the disclosure being indicated by the following claims and their equivalents.

What is claimed is:

1. A system for cleaning comprising:
an elongated element comprising:
a top part, wherein the top part is a rectilinear first portion that extends along a longitudinal axis;
a bottom part, wherein the bottom part comprises an arc that extends away from the longitudinal axis and comprises a mating component configured to receive a removably attachable head element; and
an intermediate zone, wherein the intermediate zone links the top part and bottom part;
a cleaning head element that is removably attached to the bottom part of the elongated element; and
at least one grip element that is removably attached to the top part of the elongated element and is configured to allow the elongated element to rotate free of said grip element.

2. The system for cleaning of claim 1, wherein, in the direction of the longitudinal axis, the top part of the elongated element extends over a first distance, and the bottom part of the elongated element extends over a second distance that is less than one-third of the first distance.

3. The system for cleaning of claim 1, wherein the elongated element comprises a telescopic portion between the top part and the intermediate zone.

4. The system for cleaning of claim 1, wherein the elongated element comprises a telescopic portion between the intermediate zone and the bottom part.

5. The system for cleaning of claim 1, wherein the bottom part extends away from the longitudinal axis for an arc length between 40 centimeters and 60 centimeters with an angle of 60 degrees.

6. The system for cleaning of claim 1, wherein the top part of the elongated element comprises a knob disposed at the distal end of the elongated element.

7. The system of cleaning for claim 1, wherein the grip element is moveable in rotation relative to the elongated element around the longitudinal axis.

8. The system for cleaning of claim 1, wherein the grip element comprises a molded plastic or synthetic rubber that includes ridges.

9. The system for cleaning of claim 1, wherein the grip element is made of a material that comprises at least one of ethylene-vinyl acetate, polypropylene, or polychloroprene.

10. The system for cleaning of claim 1, wherein the head element is connected to the bottom part of the elongated element with a coupling device that provides at least two degrees of freedom in rotation between the head element and elongated element.

11. The system for cleaning of claim 1, wherein the cleaning head element comprises a cleaning pad of ultrasonic-bonded construction.

12. The system for cleaning of claim 11, wherein the cleaning head element comprises:
a surface cleaning layer comprising a microfiber material;
a backing layer comprising an attachment surface; and
at least one fluid absorbing layer, comprising at least one fluid absorbing material located between the surface cleaning layer and the backing layer,
wherein the surface cleaning layer, the backing layer, and the at least one fluid absorbing layer form a multilayer composite that are integrally attached with one or more ultrasonic weld lines configured to form pockets of expansion in said multilayer composite.

13. The system for cleaning of claim 12, wherein the at least one fluid absorbing layer comprises absorptive nonwoven material.

14. The system for cleaning of claim 13, wherein the absorptive nonwoven material comprises a spun bonded polypropylene layer.

15. The system for cleaning of claim 12, wherein the attachment surface comprises a hook and loop material projecting away from the surface cleaning layer.

16. The system for cleaning of claim 1, wherein the mating component includes an assembly stem having a top element comprising a hollow tube with at least one opening located in the sidewalls of the tube, said opening having the shape of a corresponding protrusion located in or on the elongated element, wherein the opening is configured to accept with the corresponding protrusion.

17. The system for cleaning of claim 16, wherein the hollow tube of the assembly stem has a larger diameter than the elongated element.

18. The system for cleaning of claim 16, wherein the protrusions are located on a clip that is secured within the elongated element.

19. The system for cleaning of claim 18, wherein the protrusions located on the clip reversibly snap into the openings located in the sidewalls of the tube on the assembly stem to allow for attachment and detachment of the cleaning head.

20. The system for cleaning of claim 18, wherein the clip is made from a plastic and comprises polypropylene (PP); acrylonitrile butadiene styrene (ABS); polycarbonate (PC); and polyethylene (PE).
